(19) United States
(12) Patent Application Publication
(10) Pub. No.: US 2010/0217909 A1
(43) Pub. Date: Aug. 26, 2010

(54) FIELD REPLACEABLE UNIT FOR SOLID STATE DRIVE SYSTEM

(75) Inventors: Eric G. Pavol, Arvada, CO (US); David M. Rhoad, Highlands Ranch, CO (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/391,542

(22) Filed: Feb. 24, 2009

(51) Int. Cl. G06F 13/00

(52) U.S. Cl. 710/301

(57) ABSTRACT

A unit for use as a solid state drive (SSD) system. The unit may include a number of removable components that can be field serviced without having to replace the entire unit and without having to remove the unit from its operational rack support structure.

### BACKGROUND OF THE INVENTION

1. Field of the Invention

The present invention relates to removable modules of the type used within solid state drive (SSD) systems.

2. Background Art

With the explosion of data that needs to be processed efficiently and immediately accessible, companies of all sizes are looking to open source storage solutions that work with general purpose hardware. Flash-based innovations, commonly referred to as solid state drive (SSD) innovations, enable customers to immediately increase application performance and save on energy costs compared to traditional Fibre Channel hard drives. SSD technology can enable greater system utilization and scalability that will decrease server and storage sprawl in already maxed-out data centers.

Some SSD systems are subject to disruptive maintenance in that component service performed in the field requires the powering down of the system to access failed components within the system enclosure. These types of systems may require a trained service technician to access a unit having the SSD components, such as by remove or partially retracting the unit from a rack or other storage structure. The access may require complete replacement of the FRU, as disclosed in U.S. Pat. No. 6,938,181, entitled “Field Replaceable Storage Array”, the disclosure of which is hereby incorporated in its entirety. Other access may require partial retraction of the unit from the rack so that an access panel can be opened to reach one of the SSD components.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompanying drawings in which:

FIG. 1 illustrates a solid state drive system (SSD) in accordance with one non-limiting aspect of the present invention;

FIGS. 2a and 2b respectively illustrate front and rear side views of a FRU in accordance with one non-limiting aspect of the present invention;

FIGS. 3a-3b illustrates a motherboard in accordance with one non-limiting aspect of the present invention; and

FIG. 4 illustrates a removable connection to the motherboard in accordance with one non-limiting aspect of the present invention.

### DETAILED DESCRIPTION OF THE PREFERRED EMBODIMENT(S)

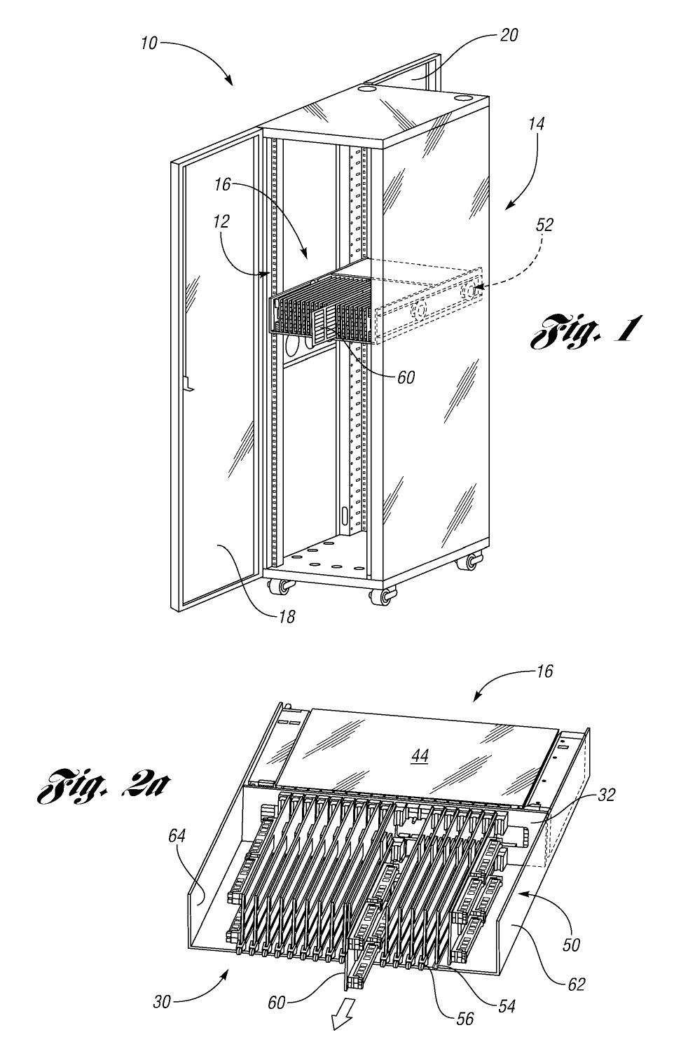

FIG. 1 illustrates a solid state drive system (SSD) 10 in accordance with one non-limiting aspect of the present invention. The SSD system 10 may include a number of racks 12 disposed within an interior of a housing 14 to hold a number of SSD units 16. The SSD unit 16 may include a number of SSD and non-SSD components to support any number of operations, such as but not limited to those commonly used to support data storage systems, servers, and other computing centers. While only the one unit 16 is shown to be loaded within a rack 12, any number of units may be loaded into the housing 14.

The housing 14 may be constructed out of metal or plastic and include four fixed side walls and front 18 and rear access panels 20. The access panels 18, 20 may be hinged to the side walls or otherwise removable to permit access to the unit 16. Electrical power and signal connections to the unit may be made through a bus or other wiring included within the housing 14. Optionally, the rack 12 may be used as a ground for the unit 16 and its components. Openings may be included within the side walls or access panels to permit wires and other electrical connections to be made directly to the unit and a bus or power supply running through the rack.

FIGS. 2a and 2b respectively illustrate front and rear side views of the unit 16 contemplated by one non-limiting aspect of the present invention. The unit 16 may be characterized by its removable components or field replaceable units (FRUs). Once secured within the rack 12, the unit 16 may be serviced without requiring handling of access panels or other protective coverings beyond the handling required to open one of the front 18 or rear access panels 20. Additionally, the removability of the components may be helpful in servicing and/or replacing discrete elements of the unit 16 without replacing the entire unit 16.

For exemplary, non-limiting purposes, the unit 16 may include a number of solid state memory cards 30, such as but not limited to Flash or Dynamic Random Access Memory (DRAM), for electronically storing data. The memory cards 30 may be collected on a forward side of a motherboard 32. The motherboard 32 may include a number of connectors 34 configured to connect the removable memory cards 30. The motherboard 32 may be configured to deliver power from a pair of power supplies 36, 38 to the memory cards 30. Optionally, the motherboard may be passive in that it only relays signal and power between connected components, as opposed to having a central processing unit (CPU) or other active components installed on it that may reduce its reliability and making it a single point of failure.

As shown in more detail in the rear partial side view of FIG. 2b, the power supplies 36, 38 may be removably secured to a rearward side of the motherboard 32. The power supplies 36, 38 may include guides 40 for supporting a side edge of a pair of concentrator cards 44, 46. Optionally, the concentrator cards 44, 46 may overlay the power supplies 36, 38 or be supported by a chassis 50. The concentrator cards 44, 46 may be switch based elements having some processing capabilities to support data conversions and transfers with the memory cards 30. While not shown, the concentrator cards 44, 46 may include any number of components to support communications with the memory cards 30 and the other operations associated with the use of the unit 16. The concentrator boards 44, 46 may also include memory of various types as well as batteries used for backing up volatile memory.

The power supplies 36, 38 may be current sharing in that each power supply 36, 38 provides an equal amount of current to the motherboard 32. If one of the power supplies 36, 38 should fail, the other can compensate for the failure by providing all of the necessary power to the motherboard 32. This can be useful to prevent loss of data access for the customer in case of a single power supply failure. A number of fans 52 may be connected to the rearward side of the motherboard 32. The fans 52 may be positioned at a far rearward end of the unit in a reverse flow orientation that causes air to flow through from the front side to the rear side of the motherboard 32.

Unlike the concentrator cards 44, 46, power supplies 36, 38, and memory cards 30, the fans 52 may not be physically connected directly by connectors included on the motherboard 32. Instead, cables or other wires (not shown) may be used to span a gap between the forward end of the fans 52 and the rearward end of the motherboard 32 for electrically connecting the fans 52 to control and power the fans 52 by way of the motherboard 32. The chassis 50 may be used to support the components and to secure the unit to the rack 12. The chassis 50 may include any type of fastener 52 sufficient to secure the unit 16 within the rack 12.

The unit 16 may be shipped as an integrated unit ready for install within the rack 12. Optionally, the chassis 50 may be metallic and used to electrically ground the unit 16 or components to the rack 12. The chassis 50 may also be used to support a bottom edge of the components, and in some case, it may also include guides 54 and locking ejector/insertion elements 56 or other features to secure an end of the components not connected to the motherboard 32. The support and connections between the chassis 50 and components may be removable to facilitate individual component replacement and servicing without having to replace or slide the entire unit out of the rack 12.

Returning to FIG. 1, one of the memory cards 60 is shown to be laterally moveable relative to a rearward end of the chassis 50. The memory card 60, like each of the other components, may be laterally removable through the corresponding end of the chassis 50, e.g., the rearward or forward end depending on the connection side to the motherboard 32, without having to lift the card 60 above a top plane of the chassis 50 defined by the tops of the opposed side walls 62, 64. In this manner, the electrically driven components in the unit 16 may be slid out of the unit 16 without having to remove the unit 16 from the rack 12 and without having to open any access opening besides one of the front 18 or rear access panels 20.

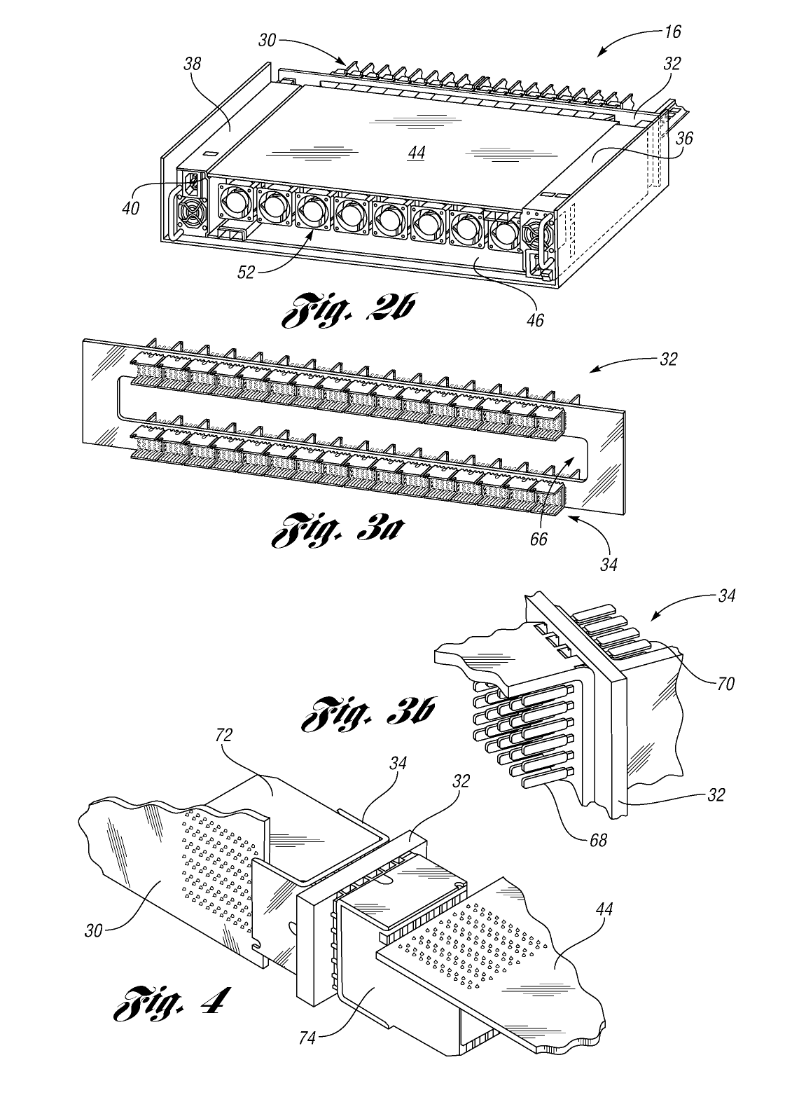

The serviceability contemplated by the present invention may be facilitated by positioning the motherboard 32 towards the center of the unit 16 so that the components can be connected to either side. FIGS. 3a-3b illustrate the motherboard 32 in accordance with one non-limiting aspect of the present invention. The motherboard 32 is shown with the forward and rearward sides being congruent and the components being removed. An air duct 66 passing through the motherboard 32 can be seen in more detail. The air duct 66 provides a through-hole from one side to the other side of the motherboard 32 to facilitate air flow and cooling of the components.

While the air duct 66 is shown to be continuous, it may also be segmented to provide any number of smaller or intermittent air ducts. Optionally, to facilitate sufficient air flow, the area of the opening defined by the air duct 66, or multiple air ducts, may be greater than a surface area of the printed wiring board (PWB) material comprising the motherboard 32. In other words, the surface area of the motherboard 32 that is obstructing air flow from one side to the other may be less than the area of the air duct 66. Orthogonal connections 34, shown in more detail in FIG. 3b, can be helpful in enabling the maximum amount of open area for air passage through the motherboard 32 for a given number of power and signal contacts.

Placement of the orthogonal connectors 34 towards the top and bottom of the motherboard 32 can maximize the airflow by removing most signals from the motherboard 32, allowing a majority of the motherboard PWB material to be cut away. This can allow more airflow by reducing the motherboard 32 constriction, which can allow the air to pass through the motherboard 32 at a slower velocity, and since pressure drop is proportional to the square of the air velocity in turbulent systems, it may have a substantial impact on total flow through the system. Thus, one non-limiting aspect of the present invention allows for the use of lower power fans 52 which are quieter, greener, and more reliable when compared with non-orthogonally coupled sets of cards.

The air duct 66 within the motherboard 32 and the midplane positioning of the motherboard 32 can be helpful in positioning the components in an orientation that allows them to be serviced while also allowing sufficient air flow to support proper temperature controls, especially if the fans 52 are only included on one side of the motherboard 32. The motherboard 32 may include the connectors 34 on both sides to connect to the components. As shown, connector terminals 68 included on one side of the motherboard may be orthogonal to the terminals 70 on the other side to facilitate the orthogonal relation of the memory cards 30 relative to the concentrator cards 44, 46.

The connectors 34 may be of a type that removes the bulk of signal routing from the motherboard 32 by using via holes instead of traces to transmit signals between the memory cards 30 and concentrator cards 44, 46. The physical embodiment of this routing is parallel to the airstream on the concentrator boards 44, 46. This can also allow the online removal and replacement of a mass of signal nets for future upgrades and enhancements. The connectors 34 may include a number of terminals 66, 68 to facilitate receiving power from the motherboard 32 and as pass-through signal mediums to pass signals between matching terminals on opposite sides of the motherboard.

FIG. 4 illustrates an exploded view of one of the memory cards 30 and one of the concentrator cards 44 as connected to the motherboard 32. Intermediary connector 72, 74 may be used to connect each of the cards to the connectors included on the motherboard. These connectors 72, 74 may be plug-in connectors or other connections that allow the cards to be pulled away from the motherboard for replacement or servicing. The illustrated orientation of the cards to the motherboard 32, facilitated with the orthogonal connectors 34, may be advantageous since it allows the concentrator cards 44, 46 to be planar in a horizontal direction without requiring the memory cards 30 to be in a similar orientation.

As demonstrated above, it may be advantageous to service the components without system downtime or top access. At the same time, it may be advantageous to obtain a high storage density per unit height (U) with acceptable cooling by opening the motherboard and grouping like sized components. Volatile memory and other memory FRU slots may be plug compatible with Flash FRU slots in order to achieve maximum configuration flexibility. The invention may include but is not limited to a 2U or 3U, 19″ rack compatible SSD system with interchangeable memory and Flash FRU slots.

Hot pluggable fans, direct current power supplies (DCPS), memory, and Flash FRUs may be accessible from the front or rear of the unit contemplated by the present invention. The midplane may use opposing through-hole connectors for minimizing high speed signal integrity risk associated with added trace length, reflections caused by physical trace transitions, vendor capability and consistency. The midplane positioned motherboard may be reduced to a simpler power and maintenance bus routing tool, minimizing the layout time needed, and reducing midplane cost by needing fewer PWB layers.

One non-limiting aspect of the present invention contemplates solving disruptive maintenance and top access issues with a hot pluggable, front and rear access unit. Also, a removable, interconnect scheme can allow an interchangeable memory or Flash FRU to exist in any physical slot to maximize configuration flexibility. The midplane design may require a minimal number of PWB layers and may be relatively inexpensive and have simple layout. The large concentrator board area may become a flexible space to create different product types such as a server board to be used in place of a host interface board.

In accordance with the present invention, failed FRU maintenance may be non-disruptive and provide a means for lower downtime and more satisfied customers who don't need to interrupt their usage when failures occur or maintenance is required. Configuration flexibility with interchangeable memory, Flash FRUs, and the large card area for the interface board can facilitate various product types. The non-active midplane can be inexpensive due to low PWB layer count and simple layout requirements while also having a high storage density per U.

One non-limiting aspect of the present invention contemplates a field replaceable unit (FRU). The FRU may include one or more of the following characteristics: a chassis having a bottom and opposed side walls; a number of discrete fans each supported by the bottom; a pair of power supplies each supported by the bottom and side walls; a number of memory cards each supported by the bottom; a number of concentrator cards; and a motherboard supported by the bottom and side walls.

Optionally, the motherboard may include a number of plug-in connectors on forward and rearward sides for removably and electrically connecting to each of the power supplies, memory cards, fans, and concentrator cards. Each of the power supplies, memory cards, fans, and concentrator cards may be orientated and connected to the motherboard to be removed laterally from a rearward or forward end of the chassis and without being lifted above a top plane defined by the top edge of the side walls. The memory cards may be connected to the forward side of the motherboard and the fans may be positioned away from the rearward side of the motherboard to cause air flow from the frontal leading edge of the memory cards through at least one air duct in the midplane over the component side of the concentrator boards and out towards the fans.

One non-limiting aspect of the present invention contemplates a solid state drive (SSD) system. The SSD system may include a housing having front and rear access panels and a number of racks accessible from a forward and rearward side upon opening of the front or rear access panels. At least one unit may be secured within one of the racks. The unit may include a number of electrically operable SSD and non-S SD components or FRU's. Optionally, each of the SSD and non-S SD components may be orientated and secured within the unit to be removed without requiring the unit to be slid out of the one of the racks.

In some cases, the unit may include a motherboard and each of at least a portion of the SSD and non-SSD components may be removably connected to opposite sides of the motherboard. For example, the non-SSD components may include a pair of power supplies, a number of fans, and a pair of concentrators and the SSD components may include a number of memory cards, such as but not limited to Flash or DRAM memory cards. Each of the components may be removable from the motherboard without having to be lifted above a plane defined by a top edge of the motherboard or side walls. Air may flow between the opposite sides of the motherboard through one or more air ducts. The air ducts may have a total that is greater than the surface area of the motherboard.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A solid state drive (SSD) unit comprising:
a chassis;
a number of fans;
a pair of power supplies;
a number of memory cards;
a number of concentrator cards;
a motherboard having a number of plug-in connectors on forward and rearward sides for removably and electrically connecting to each of the power supplies, memory cards, fans, and concentrator cards; and
wherein each of the power supplies, memory cards, fans, and concentrator cards are orientated and connected to the motherboard to be removed laterally from a rearward or forward end of the chassis and without being lifted above a top plane defined by a top side of the side walls.

2. The unit of claim 1 wherein each memory card is vertically aligned and each concentrator card is horizontally aligned.

3. The unit of claim 2 wherein each memory card is electrically connected through the motherboard to one of the concentrator cards without using traces.

4. The unit of claim 2 wherein each memory card and concentrator card is connected to the motherboard with an orthogonal connector.

5. The unit of claim 2 wherein the front and rear sides of the motherboard are congruent.

6. The unit of claim 1 wherein the motherboard includes at least one air duct extending through the forward and rearward sides.

7. The unit of claim 6 wherein the memory cards are connected to the forward side of the motherboard and the fans are positioned away from the rearward side of the motherboard to cause air flow from the memory cards through the at least one air duct towards the fans.

8. The unit of claim 1 wherein a portion of the memory cards are flash cards and DRAM cards.

9. The unit of claim 1 wherein the motherboard is positioned at a midplane of the chassis.

10. A solid state drive (SSD) system comprising:
a housing having front and rear access panels and a number of racks accessible from a forward and rearward side upon opening of the front or rear access panels; and
at least one unit secured within one of the racks, the unit having a number of electrically operable SSD and non-SSD components, wherein each of the components are orientated and secured within the unit to be removed without requiring the unit to be slid out of the rack.

11. The SSD system of claim 10 wherein the unit includes a motherboard and each of at least a portion of the SSD and non-SSD components are removably connected to opposite sides of the motherboard.

12. The SSD system of claim 11 wherein each of the components are removable from the motherboard without having to be lifted above a plane defined by a top edge of the side walls.

13. The SSD system of claim 11 wherein the motherboard includes an air duct that allows air to flow through the opposite sides of the motherboard.

14. The SSD system of claim 13 wherein an area of the air duct is greater than a surface area of the motherboard.

15. The SSD system of claim 10 wherein the non-SSD components include a pair of power supplies, a number of fans, and a pair of concentrators and the SSD components include a number of memory cards.

16. The SSD system of claim 15 wherein the concentrator cards are horizontally aligned and the memory cards are vertically aligned.

17. The SSD system of claim 16 wherein the concentrator cards and the memory cards are connected to the motherboard with orthogonal connectors.

18. A solid state drive (SSD) unit comprising:
a chassis;
a power supply;
a number of fans
a number of memory cards;
a motherboard having a number of plug-in connectors on forward and rearward sides for removably and electrically connecting to each of the power supply, memory cards and fans;
wherein the fans are positioned on one side of the motherboard and the memory cards are positioned on the other and the motherboard includes an air duct to allow air flow between the memory cards and fans.

19. The unit of claim 18 wherein the memory cards and motherboard are vertically arranged and a top and bottom side of the motherboard extends beyond a top and bottom side of the memory cards.

20. The unit of claim 19 wherein a surface area of the motherboard facing the fans is less than an area of the air duct.
